(19) United States
(12) Patent Application Publication
(10) Pub. No.: US 2026/0261169 A1
(43) Pub. Date: Sep. 3, 2026

(54) ROTARY SYSTEM HAVING A PRESS-FIT STATOR CARRIER

(71) Applicant: Schaeffler Technologies AG & Co. KG, Herzogenaurach (DE)

(72) Inventor: Noah Kee, Rittman, OH (US)

(73) Assignee: Schaeffler Technologies AG & Co. KG, Herzogenaurach (DE)

(21) Appl. No.: 19/066,974

(22) Filed: Feb. 28, 2025

(51) Int. Cl. H02K 1/18; H02K 1/20

(52) U.S. Cl. CPC H02K 1/18; H02K 1/20

(57) ABSTRACT

A rotary system includes a housing having an exterior surface and an interior surface opposite the exterior surface that defines a housing region. The interior surface of the housing includes an engagement portion. A rotor is disposed within the housing region. A stator is disposed within the housing region. A stator carrier includes an engagement portion, the stator carrier being operably coupled with the stator and defining a fluid jacket in cooperation with the interior surface of the housing. The stator carrier is engaged with the interior surface of the housing via a press-fit connection in which the engagement portion of the interior surface of the housing and the engagement portion of the stator carrier are engaged, such that friction therebetween retains the stator carrier in position relative to the housing.

### FIELD OF THE DISCLOSURE

The present disclosure generally relates to a rotary system for a vehicle. More specifically, the present disclosure relates to a generator that includes a stator carrier that is press-fit with a housing of the generator.

### BACKGROUND OF THE DISCLOSURE

Generators often include alternators and stator carriers.

### SUMMARY OF THE DISCLOSURE

According to a first aspect of the present disclosure, a rotary system includes a housing having an exterior surface and an interior surface opposite the exterior surface that defines a housing region. The interior surface of the housing includes an engagement portion. A rotor is disposed within the housing region. A stator is disposed within the housing region. A stator carrier includes an engagement portion, the stator carrier being operably coupled with the stator and defining a fluid jacket in cooperation with the interior surface of the housing. The stator carrier is engaged with the interior surface of the housing via a press-fit connection in which the engagement portion of the interior surface of the housing and the engagement portion of the stator carrier are engaged, such that friction therebetween retains the stator carrier in position relative to the housing.

Embodiments of the first aspect of the disclosure can include any one or a combination of the following features:
the stator carrier is retained in position relative to the housing via the press-fit connection without fasteners;
the stator carrier includes an outer surface that defines the fluid jacket, and the outer surface includes a protruding guide that extends axially along the outer surface of the stator carrier and protrudes radially-outboard relative to an adjacent portion of the outer surface of the stator carrier;
the interior surface of the housing includes a receiving channel that extends axially along the interior surface of the housing and extends radially-outboard relative to an adjacent portion of the interior surface of the housing to define a receiving space, and wherein the protruding guide is received within the receiving space defined by the receiving channel of the interior surface of the housing;
the protruding guide and the receiving channel are positioned proximate a top of the rotary system;
the stator carrier extends from a first axial end to a second axial end opposite the first axial end, and the first axial end is nearer than the second axial end to the engagement portion of the stator carrier;
the stator carrier includes an angled portion proximate the engagement portion that angles radially-inboard as the angled portion extends axially toward the first axial end of the stator carrier, such that interference between the interior surface of the housing and the angled portion of the stator carrier due axial movement of the stator carrier during press-fitting prompts radially-inboard compression of a portion of the stator carrier to facilitate engagement of the engagement portion of the interior surface of the housing and the engagement portion of the stator carrier; and
the rotary system is a generator that includes an alternator comprising the stator and the rotor.

According to a second aspect of the present disclosure, a rotary system includes a housing having an exterior surface and an interior surface opposite the exterior surface that defines a housing region. The interior surface of the housing includes a receiving channel that extends axially along the interior surface of the housing and extends radially-outboard relative to an adjacent portion of the interior surface of the housing to define a receiving space. A rotor is disposed within the housing region. A stator is disposed within the housing region. A stator carrier is operably coupled with the stator and defines a fluid jacket in cooperation with the interior surface of the housing. The stator carrier includes an outer surface having a protruding guide that extends axially along the outer surface of the stator carrier and protrudes radially-outboard relative to an adjacent portion of the outer surface of the stator carrier, wherein the protruding guide is received within the receiving space defined by the receiving channel of the interior surface of the housing.

Embodiments of the second aspect of the disclosure can include any one or a combination of the following features:
the interior surface of the housing includes an engagement portion, and the stator carrier includes an engagement portion, and wherein the stator carrier is engaged with the interior surface of the housing via a press-fit connection in which the engagement portion of the interior surface of the housing and the engagement portion of the stator carrier are engaged, such that friction therebetween retains the stator carrier in position relative to the housing;
the stator carrier is retained in position relative to the housing via the press-fit connection without fasteners;
the stator carrier extends from a first axial end to a second axial end opposite the first axial end, and the first axial end is nearer than the second axial end to the engagement portion of the stator carrier;
the stator carrier includes an angled portion proximate the engagement portion that angles radially-inboard as the angled portion extends axially toward the first axial end of the stator carrier, such that interference between the interior surface of the housing and the angled portion of the stator carrier due to axial movement of the stator carrier during press-fitting prompts radially-inboard compression of a portion of the stator carrier to facilitate engagement of the engagement portion of the interior surface of the housing and the engagement portion of the stator carrier;
the protruding guide and the receiving channel are positioned proximate a top of the rotary system; and
the rotary system is a generator that includes an alternator comprising the stator and the rotor.

According to a third aspect of the present disclosure, a rotary system includes a housing having an exterior surface and an interior surface opposite the exterior surface that defines a housing region. The interior surface of the housing includes an engagement portion and a receiving channel that extends axially along the interior surface of the housing and extends radially-outboard relative to an adjacent portion of the interior surface to define a receiving space. A rotor is disposed within the housing region. A stator is disposed within the housing region. A stator carrier is operably coupled with the stator and defines a fluid jacket in cooperation with the interior surface of the housing. The stator carrier includes an outer surface having an engagement portion and a protruding guide that extends axially along the outer surface of the stator carrier and protrudes radially-outboard relative to an adjacent portion of the outer surface of the stator carrier. The stator carrier is engaged with the interior surface of the housing via a press-fit connection in which the engagement portion of the interior surface of the housing and the engagement portion of the stator carrier are engaged, such that friction therebetween retains the stator carrier in a position relative to the housing in which the protruding guide is received within the receiving space defined by the receiving channel of the interior surface of the housing.

Embodiments of the third aspect of the disclosure can include any one or a combination of the following features:
the stator carrier is retained in position relative to the housing via the press-fit connection without fasteners;
the protruding guide and the receiving channel are positioned proximate a top of the rotary system;
the rotary system is a generator that includes an alternator comprising the stator and the rotor; and
a portion of the protruding guide of the stator carrier is radially aligned with a portion of the receiving channel.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a cross-sectional view of a generator that includes a housing and a stator carrier that is press-fit with an interior surface of the housing, according to one embodiment;

FIG. 2 is an enlarged view of area II taken from FIG. 1, illustrating the stator carrier in a press-fit engagement with the housing, and a protruding guide of the stator carrier received within a receiving space defined by a receiving channel of the housing, according to one embodiment;

FIG. 3 is a perspective view of a stator carrier, illustrating an outer surface of the stator carrier that includes a protruding guide that extends axially along the outer surface and protrudes radially-outboard relative to an adjacent portion of the outer surface of the stator carrier, according to one embodiment; and

FIG. 4 is a cross-sectional view of a stator carrier disposed within a housing region defined by an interior surface of a housing, illustrating a protruding guide of the stator carrier received within a receiving space defined by a receiving channel of the housing, according to one embodiment.

The components in the figures are not necessarily to scale, emphasis instead being placed upon illustrating the principles described herein.

### DETAILED DESCRIPTION

Additional features and advantages of the disclosure will be set forth in the detailed description which follows and will be apparent to those skilled in the art from the description, or recognized by practicing the disclosure as described in the following description, together with the claims and appended drawings.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

In this document, relational terms, such as “first” and “second,” “top” and “bottom,” and the like, are used solely to distinguish one entity or action from another entity or action, without necessarily requiring or implying any actual such relationship or order between such entities or actions.

For purposes of this disclosure, the term “coupled” (in all of its forms: couple, coupling, coupled, etc.) generally means the joining of two components (electrical or mechanical) directly or indirectly to one another. Such joining may be stationary in nature or movable in nature. Such joining may be achieved with the two components (electrical or mechanical) and/or any additional intermediate members. Such joining may include members being integrally formed as a single unitary body with one another (i.e., integrally coupled) or may refer to joining of two components. Such joining may be permanent in nature, or may be removable or releasable in nature, unless otherwise stated.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein, the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

As used herein, the term “axial” and derivatives thereof, such as “axially,” shall be understood to refer to a direction along an axis about which a component is configured to rotate in operation of the apparatus described herein. Further, the term “radial” and derivatives thereof, such as “radially,” shall be understood in relation to the aforementioned axis. For example, “radially outboard” refers to further away from the axis, while “radially inboard” refers to nearer to the axis. The term “circumferential” and derivatives thereof, such as “circumferentially,” shall be understood in relation to the aforementioned axis as well.

As used herein, “non-rotatably connected” elements shall be understood to refer to elements that are connected such that whenever one of the elements rotates about the axis, all of the elements rotate about the axis at a common rate of rotation, and relative rotation between the elements is restricted

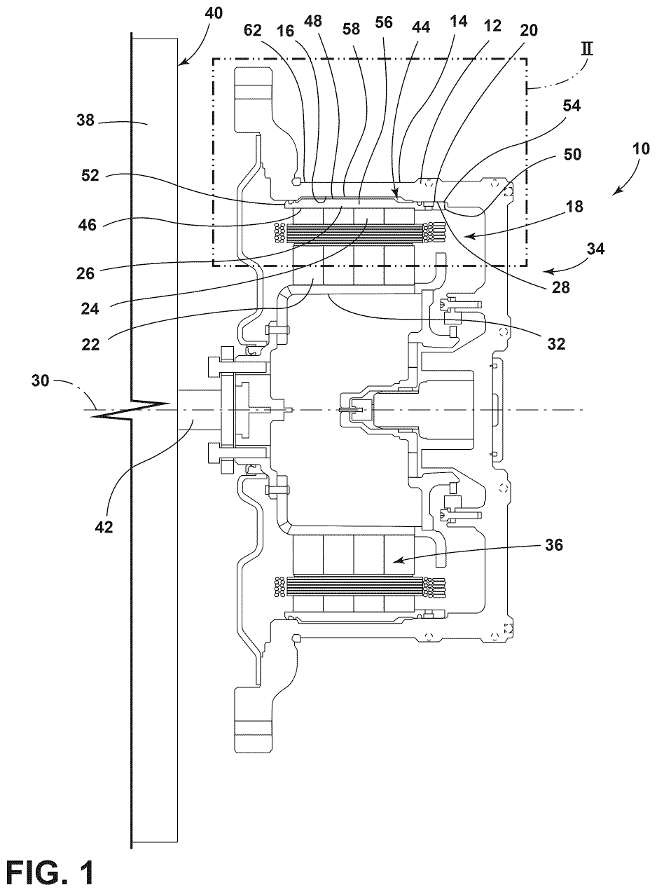

Referring now to FIGS. 1-4, a rotary system 10 includes a housing 12. The housing 12 includes an exterior surface 14 and an interior surface 16 opposite the exterior surface 14. The interior surface 16 defines a housing region 18 and includes an engagement portion 20. A rotor 22 and a stator 24 are disposed within the housing region 18. A stator carrier 26 is operably coupled with the stator 24. The stator carrier 26 defines a fluid jacket 44 in cooperation with the interior surface 16 of the housing 12. The stator carrier 26 includes an engagement portion 28. The stator carrier 26 is engaged with the interior surface 16 of the housing 12 via a press-fit connection in which the engagement portion 20 of the interior surface 16 of the housing 12 and the engagement portion 28 of the stator carrier 26 are engaged, such that friction therebetween retains the stator carrier 26 in position relative to the housing 12.

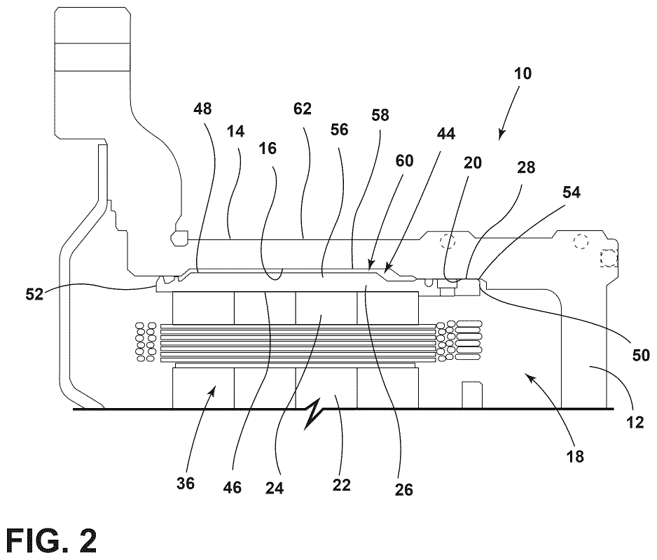

Referring now to FIGS. 1 and 2, the rotary system 10 includes the housing 12. The housing 12 can be an assembly of a plurality of components, in some examples. For example, in the embodiment illustrated in FIG. 1, the housing 12 is a die-cast aluminum housing that is formed of a plurality of opponents. The housing 12 defines the housing region 18. Various components of the rotary system 10 may be disposed in the housing region 18 defined by the housing 12, as illustrated in FIG. 1 and described further herein. The housing 12 includes the exterior surface 14 and the interior surface 16 that is opposite the exterior surface 14. As illustrated in FIG. 1, the interior surface 16 of the housing 12 defines the housing region 18.

Referring still to FIGS. 1 and 2, the rotary system 10 includes the rotor 22 and the stator 24. In the embodiment illustrated in FIGS. 1 and 2, the rotor 22 is disposed radially-inboard of the stator 24 and is operable to rotate about an axis 30 relative to the stator 24. A rotor shaft or a hub 32 may be non-rotatably connected with the rotor 22, in some embodiments. The stator 24 may be configured to drive rotation of the rotor 22 and the rotor shaft, in some implementations, or the hub 32 may be configured to drive rotation of the rotor 22 relative to the stator 24, in some implementations, as described further herein.

Referring still to FIGS. 1 and 2, in some implementations, the rotary system 10 is a generator 34, and the generator 34 includes an alternator 36 that comprises the rotor 22 and the stator 24. For example, in an exemplary embodiment, an engine 38 of a vehicle 40 drives rotation of a shaft 42. The generator 34 includes the alternator 36 having the stator 24 and the rotor 22, and the hub 32 that is operably coupled to the shaft 42 and configured to receive torque from the shaft 42 for rotation about the axis 30. The hub 32 is coupled with the rotor 22, such that rotation of the hub 32 about the axis 30 drives rotation of the rotor 22 about the axis 30 relative to the stator 24. Rotation of the rotor 22 relative to the stator 24 of the alternator 36 generates electricity for use or storage in, for example, a battery.

In some embodiments, the rotary system 10 can be a drive unit that has an electric motor that comprises the stator 24 and the rotor 22. In such embodiments, the electric motor may drive rotation of the rotor 22 relative to the stator 24 in operation thereof. A variety of types of rotary systems 10 are contemplated.

Referring still to FIGS. 1 and 2, the rotary system 10 includes the stator carrier 26. The stator carrier 26 is operably coupled with the stator 24 and cooperates with the interior surface 16 of the housing 12 to define the fluid jacket 44. As illustrated in FIG. 2, the stator carrier 26 includes an inner surface 46 that interfaces with the stator 24 and an outer surface 48 opposite the inner surface 46. The outer surface 48 of the stator carrier 26 cooperates with the interior surface 16 of the housing 12 to define the fluid jacket 44. The fluid jacket 44 may be configured to convey fluid for removal of heat from the rotary system 10, in various embodiments.

Referring still to FIGS. 1 and 2, in some embodiments, the stator carrier 26 is engaged with the interior surface 16 of the housing 12 via a press-fit connection. In the exemplary embodiment illustrated in FIG. 2, the interior surface 16 of the housing 12 includes the engagement portion 20, and the stator carrier 26 includes the corresponding engagement portion 28 that is configured to be engaged with the engagement portion 20 of the housing 12 in the press-fit arrangement of the stator carrier 16 and the housing 12. As illustrated in FIG. 2, the outer surface 48 of the stator carrier 26 includes the engagement portion 28 that corresponds with the engagement portion 20 of the interior surface 16 of the housing 12. In various implementations, the engagement portion 20 of the housing 12 is engaged with the engagement portion 28 of the stator carrier 26 via the press-fit connection, such that friction between the respective engagement portions 20, 28 retains the stator carrier 26 in position relative to the housing 12. As illustrated in FIG. 2, in some embodiments, the stator carrier 26 is retained in position relative to the housing 12 via the press-fit connection without fasteners. For example, in such embodiments, the stator carrier 26 may be retained in position relative to the housing 12 without the utilization of bolts that extend through a flange of the stator carrier 26 and into the housing 12 of the rotary system 10. Utilizing a press-fit connection between the stator carrier 26 and the housing 12 that does not require and omits the use of fasteners may advantageously reduce costs and/or increase the efficiency of manufacturing of the rotary system 10.

Referring still to FIGS. 1 and 2, in various implementations, the stator carrier 26 extends from a first axial end 50 to a second axial end 52 that is opposite the first axial end 50 of the stator carrier 26. As illustrated in FIG. 2, the first axial end 50 is nearer than the second axial end 52 to the engagement portion 28 of the stator carrier 26 that is engaged with the engagement portion 20 of the housing 12. In some embodiments, the stator carrier 26 includes an angled portion 54. The angled portion 54 may be disposed proximate to the engagement portion 28 of the stator carrier 26. As illustrated in FIG. 2, the angled portion 54 angles radially-inboard as the angled portion 54 extends axially toward the first axial end 50 of the stator carrier 26. As such, in the process of press-fitting the stator carrier 26 and the housing 12, wherein the stator carrier 26 moves axially into the housing 12 in the axial direction from which the stator carrier 26 extends from the second axial end 52 to the first axial end 50, interference between the interior surface 16 of the housing 12 and the angled portion 54 of the stator carrier 26 occurs. This interference prompts radially-inboard compression of a portion of the stator carrier 26 to facilitate engagement of the engagement portion 20 of the interior surface 16 of the housing 12 and the engagement portion 28 of the stator carrier 26 to form the press-fit connection.

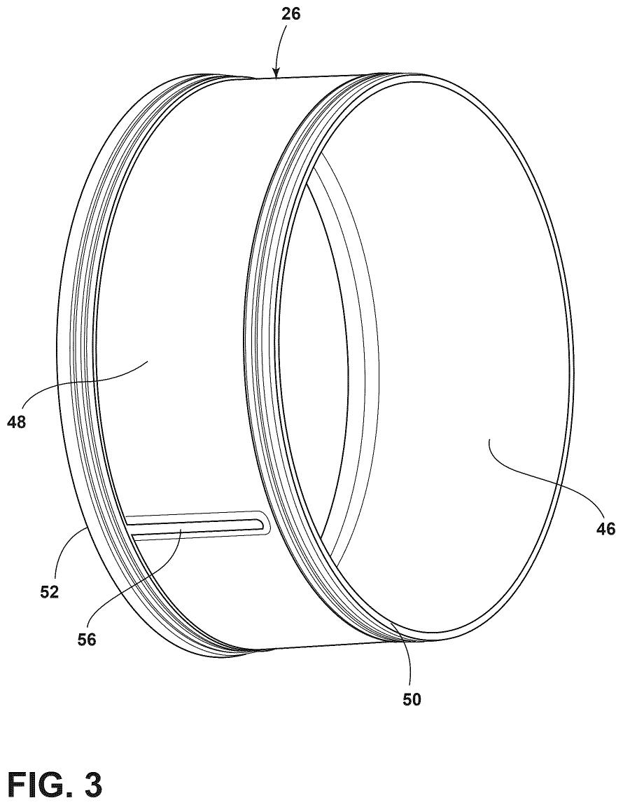

Referring now to FIGS. 1-4, in some embodiments, the outer surface 48 of the stator carrier 26 includes a protruding guide 56. As illustrated in FIG. 3, the protruding guide 56 extends axially along the outer surface 48 of the stator carrier 26 and protrudes radially-outboard relative to an adjacent portion of the outer surface 48 of the stator carrier 26. In some embodiments, the interior surface 16 of the housing 12 includes a receiving channel 58. The receiving channel 58 extends axially along the interior surface 16 of the housing 12 and extends radially-outboard relative to an adjacent portion of the interior surface 16 of the housing 12 to define a receiving space 60. In various embodiments, the protruding guide 56 is received within the receiving space 60 defined by the receiving channel 58 of the interior surface 16 of the housing 12 in the press-fit arrangement between the housing 12 and the stator carrier 26, as illustrated exemplarily in FIGS. 1 and 2.

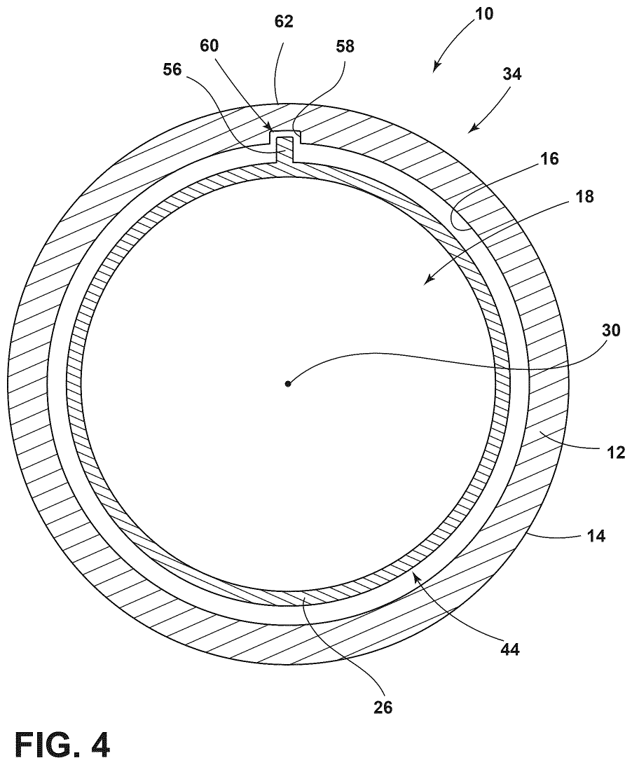

As illustrated in FIG. 4, in the assembled condition of the rotary system 10, the protruding guide 56 of the stator carrier 26 is received within the receiving space 60 defined by the receiving channel 58, and a portion of the protruding guide 56 of the stator carrier 26 is radially aligned with a portion of the receiving channel 58. This radial alignment between the respective portions of the protruding guide 56 and the receiving channel 58 allow the protruding guide 56 and the receiving channel 58 to respectively serve as a key and a keyway to align the stator carrier 26 with the housing 12 for press-fitting of the components. As further illustrated in FIG. 4, in various embodiments, the receiving channel 58 of the housing 12 and the protruding guide 56 of the stator carrier 26 are disposed proximate a top 62 of the rotary system 10. In some implementations, the protruding guide 56 and the receiving channel 58 are circumferentially aligned with the uppermost portion of a circumference defined relative to the axis 30 about which the rotor 22 rotates, wherein the circumference has a radius that is radially aligned with both a portion of the protruding guide 56 and a portion of the receiving channel 58.

The rotary system 10 of the present disclosure may provide a variety of advantages. First, the stator carrier 26 being retained relative to the housing 12 via a press-fit connection rather than fasteners may decrease the cost of the rotary system 10 and increase the efficiency of manufacturing. Second, the protruding guide 56 may advantageously serve as a fluid flow divider within the fluid jacket 44 in an assembled condition of the rotary system 10 and may serve as a key received within the receiving space 60 defined by the receiving channel 58 of the housing 12 to align the stator carrier 26 and the housing 12 correctly during the press fitting process.

It is to be understood that variations and modifications can be made on the aforementioned structure without departing from the concepts of the present disclosure, and further it is to be understood that such concepts are intended to be covered by the following claims unless these claims by their language expressly state otherwise.

### List of Reference Numerals

1
0 rotary system
1
2 housing
1
4 exterior surface
1
6 interior surface
1
8 housing region
2
0 engagement portion (of housing)
2
2 rotor
2
4 stator
2
6 stator carrier
2 (of stator
8 engagement portion carrier)
3
0 axis
3
2 hub
3
4 generator
3
6 alternator
3
8 engine
4
0 vehicle
4
2 shaft
4
4 fluid jacket
4
6 inner surface
4
8 outer surface
5
0 first axial end
5
2 second axial end
5
4 angled portion
5
6 protruding guide
5
8 receiving channel
6
0 receiving space
6
2 top

What is claimed is:

1. A rotary system, comprising:
a housing having an exterior surface and an interior surface opposite the exterior surface that defines a housing region, wherein the interior surface of the housing includes an engagement portion;
a rotor disposed within the housing region;
a stator disposed within the housing region; and
a stator carrier that includes an engagement portion, the stator carrier being operably coupled with the stator and defining a fluid jacket in cooperation with the interior surface of the housing, wherein the stator carrier is engaged with the interior surface of the housing via a press-fit connection in which the engagement portion of the interior surface of the housing and the engagement portion of the stator carrier are engaged, such that friction therebetween retains the stator carrier in position relative to the housing.

2. The rotary system of claim 1, wherein the stator carrier is retained in position relative to the housing via the press-fit connection without fasteners.

3. The rotary system of claim 1, wherein the stator carrier includes an outer surface that defines the fluid jacket, and the outer surface includes a protruding guide that extends axially along the outer surface of the stator carrier and protrudes radially-outboard relative to an adjacent portion of the outer surface of the stator carrier.

4. The rotary system of claim 3, wherein the interior surface of the housing includes a receiving channel that extends axially along the interior surface of the housing and extends radially-outboard relative to an adjacent portion of the interior surface of the housing to define a receiving space, and wherein the protruding guide is received within the receiving space defined by the receiving channel of the interior surface of the housing.

5. The rotary system of claim 4, wherein the protruding guide and the receiving channel are positioned proximate a top of the rotary system.

6. The rotary system of claim 1, wherein the stator carrier extends from a first axial end to a second axial end opposite the first axial end, and the first axial end is nearer than the second axial end to the engagement portion of the stator carrier.

7. The rotary system of claim 6, wherein the stator carrier includes an angled portion proximate the engagement portion of the stator carrier that angles radially-inboard as the angled portion extends axially toward the first axial end of the stator carrier, such that interference between the interior surface of the housing and the angled portion of the stator carrier due axial movement of the stator carrier during press-fitting prompts radially-inboard compression of a portion of the stator carrier to facilitate engagement of the engagement portion of the interior surface of the housing and the engagement portion of the stator carrier.

8. The rotary system of claim 1, wherein said rotary system is a generator that includes an alternator comprising the stator and the rotor.

9. A rotary system, comprising:
a housing having an exterior surface and an interior surface opposite the exterior surface that defines a housing region, wherein the interior surface of the housing includes a receiving channel that extends axially along the interior surface of the housing and extends radially-outboard relative to an adjacent portion of the interior surface of the housing to define a receiving space;
a rotor disposed within the housing region;
a stator disposed within the housing region; and
a stator carrier that is operably coupled with the stator and defines a fluid jacket in cooperation with the interior surface of the housing, the stator carrier having an outer surface that includes a protruding guide that extends axially along the outer surface of the stator carrier and protrudes radially-outboard relative to an adjacent portion of the outer surface of the stator carrier, wherein the protruding guide is received within the receiving space defined by the receiving channel of the interior surface of the housing.

10. The rotary system of claim 9, wherein the interior surface of the housing includes an engagement portion, and the stator carrier includes an engagement portion, and wherein the stator carrier is engaged with the interior surface of the housing via a press-fit connection in which the engagement portion of the interior surface of the housing and the engagement portion of the stator carrier are engaged, such that friction therebetween retains the stator carrier in position relative to the housing.

11. The rotary system of claim 10, wherein the stator carrier is retained in position relative to the housing via the press-fit connection without fasteners.

12. The rotary system of claim 10, wherein the stator carrier extends from a first axial end to a second axial end opposite the first axial end, and the first axial end is nearer than the second axial end to the engagement portion of the stator carrier.

13. The rotary system of claim 12, wherein the stator carrier includes an angled portion proximate the engagement portion of the stator carrier that angles radially-inboard as the angled portion extends axially toward the first axial end of the stator carrier, such that interference between the interior surface of the housing and the angled portion of the stator carrier due to axial movement of the stator carrier during press-fitting prompts radially-inboard compression of a portion of the stator carrier to facilitate engagement of the engagement portion of the interior surface of the housing and the engagement portion of the stator carrier.

14. The rotary system of claim 9, wherein the protruding guide and the receiving channel are positioned proximate a top of the rotary system.

15. The rotary system of claim 9, wherein said rotary system is a generator that includes an alternator comprising the stator and the rotor.

16. A rotary system, comprising:
a housing having an exterior surface and an interior surface opposite the exterior surface that defines a housing region, wherein the interior surface of the housing includes an engagement portion and a receiving channel that extends axially along the interior surface of the housing and extends radially-outboard relative to an adjacent portion of the interior surface to define a receiving space;
a rotor disposed within the housing region;
a stator disposed within the housing region; and
a stator carrier that is operably coupled with the stator and defines a fluid jacket in cooperation with the interior surface of the housing, the stator carrier having an outer surface that includes an engagement portion and a protruding guide that extends axially along the outer surface of the stator carrier and protrudes radially-outboard relative to an adjacent portion of the outer surface of the stator carrier, wherein the stator carrier is engaged with the interior surface of the housing via a press-fit connection in which the engagement portion of the interior surface of the housing and the engagement portion of the stator carrier are engaged, such that friction therebetween retains the stator carrier in a position relative to the housing in which the protruding guide is received within the receiving space defined by the receiving channel of the interior surface of the housing.

17. The rotary system of claim 16, wherein the stator carrier is retained in position relative to the housing via the press-fit connection without fasteners.

18. The rotary system of claim 16, wherein the protruding guide and the receiving channel are positioned proximate a top of the rotary system.

19. The rotary system of claim 16, wherein said rotary system is a generator that includes an alternator comprising the stator and the rotor.

20. The rotary system of claim 16, wherein a portion of the protruding guide of the stator carrier is radially aligned with a portion of the receiving channel.
